(19) United States
(12) Patent Application Publication
(10) Pub. No.: US 2026/0267296 A1
(43) Pub. Date: Sep. 10, 2026

(54) METHODS AND RELATED ASPECTS TO ASSURE ARTIFICIAL INTELLIGENCE SYSTEMS

(71) Applicant: THE JOHNS HOPKINS UNIVERSITY, Baltimore, MD (US)

(72) Inventors: Yair AMIR, Bethesda, MD (US); Brian J. WHEATMAN, Baltimore, MD (US); Guangrui CHEN, Baltimore, MD (US); Tamim SOOKOOR, Laurel, MD (US)

(21) Appl. No.: 18/876,296

(22) PCT Filed: Jun. 20, 2023
(86) PCT No.: PCT/US2023/025703

§ 371 Date: Dec. 18, 2024

Related U.S. Application Data
(60) Provisional application No. 63/354,058, filed on Jun. 21, 2022.

(51) Int. Cl. G05B 13/02

(52) U.S. Cl. CPC G05B 13/027

(57) ABSTRACT

Provided herein are systems of assuring artificial intelligence (AI) systems that include an infrastructure component configured to produce at least one infrastructure output, a black-box monitoring subsystem configured to receive state information from the infrastructure component and to communicate with at least one decision module component, a white-box monitoring subsystem configured to receive the state information from the infrastructure component and to communicate with the at least one decision module component; and a safe controller and an artificial intelligence (AI) controller configured to receive the state information from the infrastructure component. Computer readable media and methods, and related aspects of assuring artificial intelligence (AI) systems are also provided.

### CROSS-REFERENCE TO RELATED APPLICATONS

This is the national stage entry of International Patent Application No. PCT/US2023/025703, filed on Jun. 20, 2023, and published as WO 2023/249927 A1 on Dec. 28, 2023, which claims the benefit of U.S. Provisional Patent Application Ser. No. 63/354,058, filed on Jun. 21, 2022, which are hereby incorporated by reference in their entireties.

### BACKGROUND

The majority of the world population is projected to live in urban areas by 2050. To support this rapid increase, we need to modernize our aging infrastructure with controllers that can constantly optimize the system's performance, such as with machine learning techniques. In recent years, AI/ML deep neural networks (DNN) have brought dramatic improvements to diverse tasks such as automatic speech recognition, natural language processing, image recognition, medical image analysis, bioinformatics, and autonomous driving. One of the main limitations of these techniques is their opaque failure modes: it is difficult to understand exactly how these systems work and predict when and how they will fail.

In the vast majority of cases, these systems yield incredible results, much better than what was possible just a few years ago. However, in rare cases, they fail spectacularly in unexpected ways, often ones that are hard for humans to accept. It looks like the AI system that worked perfectly in so many complex situations failed miserably in a case that looks obvious to the human eye. Even if that error can be fixed in the DNN through additional learning, it is not clear how to generalize this concept to other potential errors, and the suspicion is that the distribution of these erroneous edge cases is such that no amount of training will assure that all real-life situations would be covered. We believe two key issues should be addressed before such AI systems can be assured: (1) fault tolerance and (2) ML competence.

The complicated nature and scale of these systems make them infeasible to model with high fidelity to provide strong design-time certification. Traditional Simplex-based approaches for fault tolerance in safety critical systems may not be sufficient. These approaches can either be too lax and allow the system to enter unsafe states or encumber the system such that no performance can be gained from autonomy. However, some method of fault tolerance is required since edge cases and adversarial inputs seem inherent in many AI based solutions.

Accordingly, there is a need for assuring AI systems.

### SUMMARY

In one aspect, the present disclosure relates to a system that includes an infrastructure component (e.g., a power grid system, a traffic light system, etc.) configured to produce at least one infrastructure output. The system also includes a black-box monitoring subsystem configured to receive state information from the infrastructure component and to communicate with at least one decision module component. The system also includes a white-box monitoring subsystem configured to receive state information from the infrastructure component and to communicate with at least one decision module component. In addition, the system also includes a safe controller and an artificial intelligence (AI) controller configured to receive the state information from the infrastructure component, which safe and AI controllers comprise at least one processor and at least one memory communicatively coupled to the at least one processor, which at least one memory stores instructions which, when executed on the at least one processor, perform operations comprising: receiving the state information at least at the safe and AI controllers; using the AI controller to control the infrastructure output of the infrastructure component when the state information indicates that the system is in a safe region; using the safe controller to control the infrastructure output of the infrastructure component when the state information indicates that the system is in a danger region; and using output produced by the white-box monitoring subsystem to select whether to use the AI controller or the safe controller to control the infrastructure output of the infrastructure component when the state information indicates that the system is in a questionable region. In some embodiments, the at least one decision module component comprises a black-box decision module and a white-box decision module, which white-box decision module communicates with the black-box decision module. In another aspect, the present disclosure provides a method of controlling the infrastructure output of the infrastructure component using a system as described herein.

In another aspect, the present disclosure relates to a computer readable media comprising non-transitory computer executable instruction which, when executed by at least one electronic processor of a system, perform at least: receiving state information at least at safe and artificial intelligence (AI) controllers configured to receive the state information from an infrastructure component; using the AI controller to control infrastructure output of the infrastructure component when the state information indicates that the system is in a safe region; using the safe controller to control the infrastructure output of the infrastructure component when the state information indicates that the system is in a danger region; and, using output produced by a white-box monitoring subsystem to select whether to use the AI controller or the safe controller to control the infrastructure output of the infrastructure component when the state information indicates that the system is in a questionable region. In some embodiments, the white-box monitoring subsystem comprises a plurality of white-box monitoring components. In some embodiments, at least one decision module component of the system comprises a black-box decision module and the white-box decision module, which white-box decision module communicates with the black-box decision module. In some embodiments, the infrastructure component comprises a power grid system. In some embodiments, the infrastructure component comprises a traffic light system. In some embodiments, the system comprises an electronic neural network.

In another aspect, the present disclosure relates to a method of controlling an infrastructure output of an infrastructure component using a system comprising a computer, the method comprising: receiving, by the computer, state information at least at safe and artificial intelligence (AI) controllers of the system, which safe and AI controllers are configured to receive the state information from the infrastructure component; using the AI controller to control infrastructure output of the infrastructure component when the state information indicates that the system is in a safe region; using the safe controller to control the infrastructure output of the infrastructure component when the state information indicates that the system is in a danger region; and, using output produced by a white-box monitoring subsystem to select whether to use the AI controller or the safe controller to control the infrastructure output of the infrastructure component when the state information indicates that the system is in a questionable region. In some embodiments, the white-box monitoring subsystem comprises a plurality of white-box monitoring components. In some embodiments, at least one decision module component of the system comprises a black-box decision module and the white-box decision module, which white-box decision module communicates with the black-box decision module. In some embodiments, the infrastructure component comprises a power grid system. In some embodiments, the infrastructure component comprises a traffic light system. In some embodiments, the system comprises an electronic neural network. In some embodiments, the method includes adjusting the infrastructure output of the infrastructure component when the state information indicates that the system is in the questionable region.

### BRIEF DESCRIPTION OF THE DRAWINGS

The accompanying drawings, which are incorporated in and constitute a part of this specification, illustrate certain embodiments, and together with the written description, serve to explain certain principles of the methods, devices, kits, systems, and related computer readable media disclosed herein. The description provided herein is better understood when read in conjunction with the accompanying drawings which are included by way of example and not by way of limitation. It will be understood that like reference numerals identify like components throughout the drawings, unless the context indicates otherwise. It will also be understood that some or all of the figures may be schematic representations for purposes of illustration and do not necessarily depict the actual relative sizes or locations of the elements shown.

FIG. 1 is a flow chart that schematically shows exemplary method steps of controlling an infrastructure output of an infrastructure component using a system comprising a computer according to some aspects disclosed herein.

FIG. 2 is a schematic diagram of an exemplary system suitable for use with certain aspects disclosed herein.

FIG. 3 A and B: Basic black-box monitoring overview. (a) Black-box monitoring system diagram. System state is collected from the environment and sent to the two controllers and the black-box monitor. Each controller issues a command and sends it to the decision module. The decision module takes these two commands along with a fault distance from the monitor to create an action. (b) The AI controller influences behavior when any invariant is not in danger of being violated and thus is in the Safe Region. The monitor determines whether the system is in the Danger Region and then the safe controller takes over to avoid the possibility of reaching the Failed Region.

FIG. 4: White-box monitoring decision module. When the system is in the Questionable Region, the decision monitor uses the output from the white-box monitor to select which controller to use. This can allow us to switch away from the AI controller sooner when it is unsure and likely to have bad results.

FIG. 5: RADICS System diagram. In addition to the black-box monitoring system in FIG. 3a, we add white-box monitoring which receives state from the AI controller and determines the AI's certainty in its decision. The decision modules use this extra information to improve the performance of the system.

### DEFINITIONS

In order for the present disclosure to be more readily understood, certain terms are first defined below. Additional definitions for the following terms and other terms may be set forth throughout the specification. If a definition of a term set forth below is inconsistent with a definition in an application or patent that is incorporated by reference, the definition set forth in this application should be used to understand the meaning of the term.

As used in this specification and the appended claims, the singular forms “a,” “an,” and “the” include plural references unless the context clearly dictates otherwise. Thus, for example, a reference to “a method” includes one or more methods, and/or steps of the type described herein and/or which will become apparent to those persons skilled in the art upon reading this disclosure and so forth.

It is also to be understood that the terminology used herein is for the purpose of describing particular embodiments only and is not intended to be limiting. Further, unless defined otherwise, all technical and scientific terms used herein have the same meaning as commonly understood by one of ordinary skill in the art to which this disclosure pertains. In describing and claiming the methods, systems, and computer readable media, the following terminology, and grammatical variants thereof, will be used in accordance with the definitions set forth below.

Electronic neural network: As used herein, “electronic neural network” refers to a machine learning algorithm or model that includes layers of at least partially interconnected artificial neurons (e.g., perceptrons or nodes) organized as input and output layers with one or more intervening hidden layers that together form a network that is or can be trained to classify data, such as test subject medical data sets (e.g., medical images or the like). In some embodiments, a “deep neural network” or “DNN” comprises the electronic neural network.

Machine Learning Algorithm: As used herein, “machine learning algorithm” generally refers to an algorithm, executed by computer, that automates analytical model building, e.g., for clustering, classification or pattern recognition. Machine learning algorithms may be supervised or unsupervised. Learning algorithms include, for example, artificial neural networks (e.g., back propagation networks), discriminant analyses (e.g., Bayesian classifier or Fisher's analysis), multiple-instance learning (MIL), support vector machines, decision trees (e.g., recursive partitioning processes such as CART-classification and regression trees, or random forests), linear classifiers (e.g., multiple linear regression (MLR), partial least squares (PLS) regression, and principal components regression), hierarchical clustering, and cluster analysis. A dataset on which a machine learning algorithm learns can be referred to as “training data.” A model produced using a machine learning algorithm is generally referred to herein as a “machine learning model.”

### DETAILED DESCRIPTION

Reference will now be made in detail to example implementations. These embodiments are described in sufficient detail to enable those skilled in the art to practice the invention and it is to be understood that other embodiments may be utilized and that changes may be made without departing from the scope of the invention. The following description is, therefore, merely exemplary.

### I. Introduction

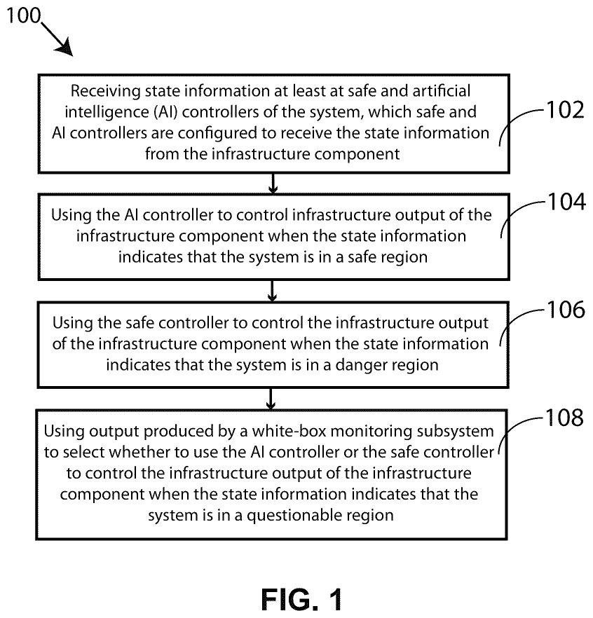

To illustrate, FIG. 1 is a flow chart that schematically shows exemplary method steps of controlling an infrastructure output of an infrastructure component using a system comprising a computer. As shown, method 100 includes receiving, by the computer, state information at least at safe and artificial intelligence (AI) controllers of the system, which safe and AI controllers are configured to receive the state information from the infrastructure component (step 102). Method 100 also includes using the AI controller to control infrastructure output of the infrastructure component when the state information indicates that the system is in a safe region (step 104). Method 100 also includes using the safe controller to control the infrastructure output of the infrastructure component when the state information indicates that the system is in a danger region (step 106). In addition, method 100 also includes using output produced by a white-box monitoring subsystem to select whether to use the AI controller or the safe controller to control the infrastructure output of the infrastructure component when the state information indicates that the system is in a questionable region (step 108).

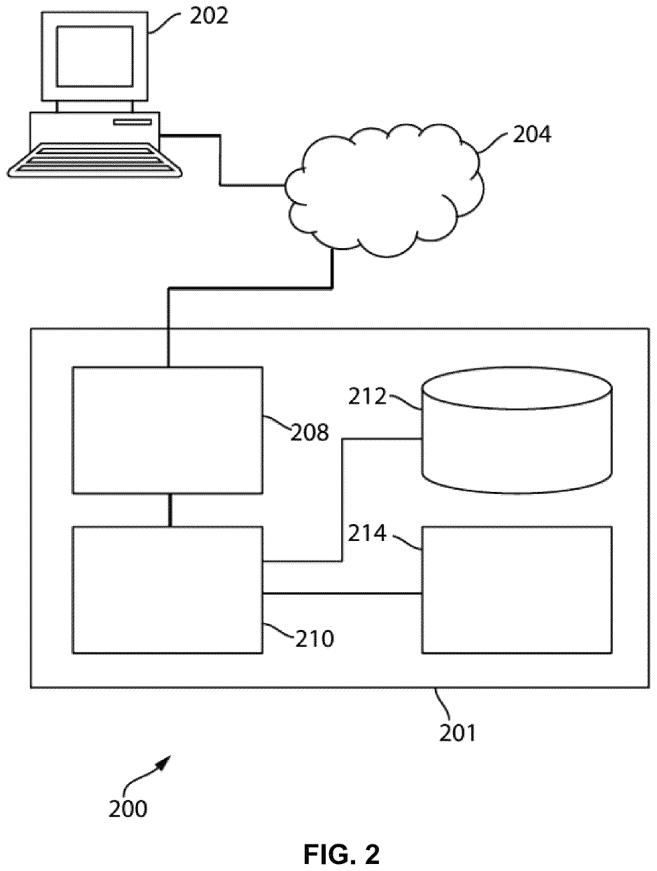

FIG. 2 is a schematic diagram of a hardware computer system 200 suitable for implementing various embodiments. For example, FIG. 2 illustrates various hardware, software, and other resources that can be used in implementations of any of methods disclosed herein, including method 100 and/or one or more instances of an electronic neural network. System 200 includes training corpus source 202 and computer 201. Training corpus source 202 and computer 201 may be communicatively coupled by way of one or more networks 204, e.g., the internet.

Computer 201 may be implemented as any of a desktop computer, a laptop computer, can be incorporated in one or more servers, clusters, or other computers or hardware resources, or can be implemented using cloud-based resources. Computer 201 includes volatile memory 214 and persistent memory 212, the latter of which can store computer-readable instructions, that, when executed by electronic processor 210, configure computer 201 to perform any of the methods disclosed herein, including method 100, and/or form or store any electronic neural network, and/or perform any classification technique as described herein. Computer 201 further includes network interface 208, which communicatively couples computer 201 to training corpus source 202 via network 204. Other configurations of system 200, associated network connections, and other hardware, software, and service resources are possible.

Certain embodiments can be performed using a computer program or set of programs. The computer programs can exist in a variety of forms both active and inactive. For example, the computer programs can exist as software program(s) comprised of program instructions in source code, object code, executable code or other formats; firmware program(s), or hardware description language (HDL) files. Any of the above can be embodied on a transitory or non-transitory computer readable medium, which include storage devices and signals, in compressed or uncompressed form. Exemplary computer readable storage devices include conventional computer system RAM (random access memory), ROM (read-only memory), EPROM (erasable, programmable ROM), EEPROM (electrically erasable, programmable ROM), and magnetic or optical disks or tapes.

### II. Description of Example Embodiments

In some aspects, the present disclosure provides RADICS: Runtime Assurance of Distributed Intelligent Control Systems, to help solve intelligent control system problems. In some embodiments, RADICS uses both black and white box monitoring in a Simplex-like approach to create a reliable system that achieves good performance on average, without suffering from failure cases as straight AI systems do. A decision module takes input from both monitors to determine the correct action.

In some embodiments, the black-box monitor ensures correctness by detecting when the system is on a failure trajectory and switches to a provably safe, but less effective algorithm. When the safe algorithm has righted the system, control is given back to the AI controller.

In some embodiments, the white-box monitors help improve the performance by predicting when the system might begin a failure trajectory. The white-box monitors can detect when the AI controller is unsure of the correct action. This indicates it might be worth switching to the safe algorithm sooner, to avoid paying the full cost associated with declining performance to the blackbox threshold. Different styles of white-box monitors can be used to improve the overall system's ability to understand how confident the AI controller is in its action, depending on the situation.

In some embodiments, the white-box monitors can only impact the decision in the direction of the safe controller, when the black-box monitor determines a possible fault, the safe controller will always be used. However, when the black-box monitor does not detect a fault, the white-box monitors can still push it away from the AI controller to the safe controller.

In some embodiments, the White-Box monitors have previously been used as an out-of-distribution test, which are able to determine when an input is out of the training distribution and thus likely to result in a bad decision.

In some embodiments, RADICS involves a few preconditions. The first is that no single decision can lead to a total system failure. If any single decision can lead to failure, then any black-box monitoring approach would always have to let the safe algorithm control the system else failure would be possible, which defeats the purpose of having any other controller. This likely eliminates some applications such as self-driving cars, but still allows for many other system control problems where the system can gradually fall into bad states.

A second precondition is that a safe alternative algorithm is known. If the safe algorithm is provably correct, RADICS can ensure the whole system is safe, while still improving system performance. If no provable safe algorithm is known, then RADICS cannot guarantee correctness. However, even if we cannot find a provably good algorithm, RADICS can still be useful. If some algorithm is currently being used to solve the problem and has been deemed acceptable, then RADICS can achieve performance at least as good in the worst case, and normally better, failing, at most, as often as the acceptable algorithm. Allowing us to improve current systems without introducing new failure modes.

### Contributions

1) We introduce the RADICS architecture, the first to combine black and white box monitoring to maximize the performance of assured AI systems.
2) We present three general approaches to white-box monitors with varying computational costs.
3) We present a traffic control case study to show the effectiveness of the RADICS architecture, along with an investigation into the effectiveness of each style of white-box monitoring for traffic control.

### RADICS Architecture

In some embodiments, RADICS is an architecture for creating high accuracy, dependable AI systems by combining highly accurate AI techniques with monitors to ensure correctness. RADICS uses both black and white box monitoring to maintain high accuracy, while ensuring correctness. We first describe how to use blackbox monitoring in a standard simplex-like approach and then extend this to take advantage of white-box monitoring.

### A. Black-Box Monitoring

Black-box monitoring is a standard approach for creating reliable systems. A black-box monitoring system involves four major components: a safe controller, which is able to control the situation in an acceptable manner; an untrustworthy controller, which has better average performance, but may suffer from unacceptable faults; a monitor, which looks at the state of the entire system and determines if the system is in a good state; and a decision module, which chooses which controller to use at any point in time.

a) Safe Controller: The safe controller is fully capable of controlling the system in any state. The safe controller can be a simple, static algorithm, which has theoretical guarantees about its performance. However, this safety often comes at a cost and thus the safe controller is expected to have worse performance on average. In situations where provably good safe controllers are hard to create, the need for them can be alleviated with a small amount of risk. If the problem is currently being solved, then there is some solution which has an acceptable level of risk. This solution can be used instead of a provably safe controller and RADICS will allow the overall system performance to increase, while still only failing in the situations where the existing solution would fail.

b) AI controller: The AI controller is also capable of controlling the overall system. It should, on average, perform better than the safe controller. However, the AI system may incur unacceptable faults. AI systems are expected to be able to perform much better on the common case, but current research indicates that there will always be edge cases or adversarial scenarios that exist and cannot be eliminated by more training, thus the need for a higher level system such as RADICS.

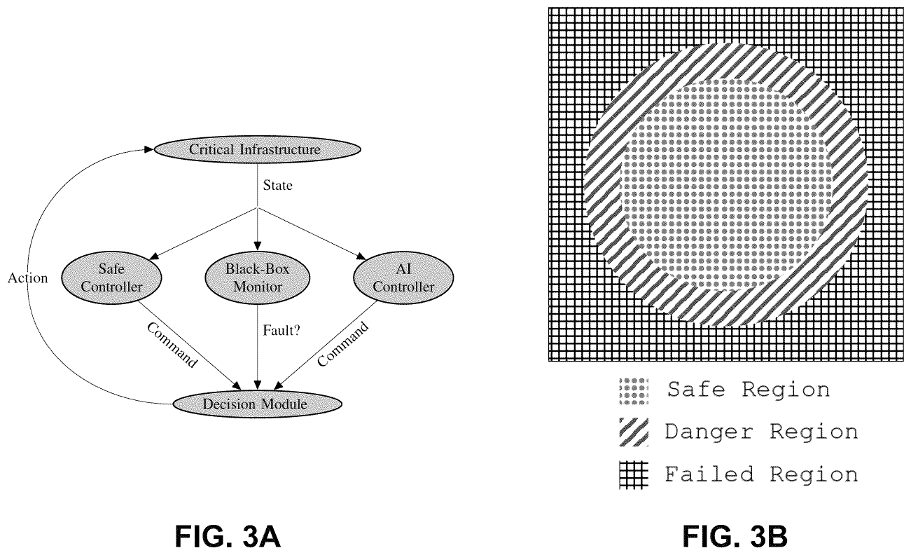

c) Black-Box Monitor: The black-box monitor looks at the overall state of the system and determines how far the system is from breaking any invariant. To ensure correctness the black-box monitor must always be able to determine when the system is within some distance from any failure state. This is equivalent to saying which state from FIG. 3b we are in.

d) Decision Module: The decision module is responsible for determining when the system should switch between controllers. It chooses the safe controller whenever it needs to so that it can ensure correctness and the AI controller to improve overall performance since the AI controller is expected to outperform the safe controller in common situations. The decision module will select the action of the AI controller if and only if the black-box monitor determines that the system is far from any failure region.

The system, which can be seen in FIG. 3a, works as follows: State is collected from the environment and sent to two controllers, one known or proven to be safe, and an AI controller, which is expected to give better performance on average. State is also sent to a black-box monitor, which can detect if the system is close to any failure region. Each controller proposes an action and sends it to the decision module. The monitor sends information about how far the system is from breaking invariants. The decision module uses this distance and the state information to choose between actions. When the system is in the Safe Region, as shown in FIG. 3b, the AI can control the system since there is no possibility of failure. When the system enters the Danger Region, the decision monitor selects the safe controller, so the system has time to right itself before it reaches the Failed Region.

The decision to switch to the safe algorithm from the AI controller is straightforward. It takes some amount of time for the safe controller to right the system after being given control. We can determine how far it can continue to degrade after switching to the safe controller. Whenever we are within this range, we switch to the safe controller so that it always has enough time to right the system before it fails. This range is represented by the red region in FIG. 3b.

The decision to switch back is similar. Whenever the system is far enough from the failure zone (outside the red zone), the system switches to the AI controller. This switching approach will perform correctly in all cases, but can impact performance. One such case is if the system is in a long-term state which the AI has not trained properly for. This case causes oscillation as follows:
1) The environment is in a state the AI is not trained for
2) As system performance degrades, the system switches to the safe controller
3) Once the performance has stabilized, the system switches back to the AI controller
4) The AI controller still fails at this case and thus performance falls until it switches back to the safe controller

The oscillation will cause worse system performance than using the safe controller by itself, since each time the AI controller is used it will result in a drop in performance that the safe controller needs to fix.

This oscillation can be handled by using simple timers. After switching to the safe controller, the decision module requires that it stays there for some amount of time. This timer amortizes the cost of switching over a longer period of guaranteed performance from the safe controller.

Black-box monitoring has previously been used for AI systems. However, only using a black-box monitor limits the types of switching mechanisms that can be used. Sometimes these systems are overly conservative, such as in, where once the system has switched to a safe controller, it remains there until reset manually. Another approach uses reachability analysis to determine that it will stay in the Safe Region for at least some number of steps, but this can lead to oscillations as shown above unless timers or other such mechanisms are used.

### B. White-Box Monitoring

One of the problems with black-box monitoring is that the system does not know anything is wrong until we are already in a bad state. This, along with the fact that it can take some amount of time for the safe controller to right the system, causes a dip in performance whenever the AI controller is incapable of handling the situation. We can help alleviate some of these issues with white-box monitoring, which can look into the state of the AI controller, and thus have a better idea of how it is behaving. The general idea is that the white-box monitors will be able to predict when the AI controller is likely to make a mistake and switch to the safe controller earlier, as, or even before, the performance starts to degrade, before the black-box monitor can detect anything is amiss. We first describe how white-box monitors work in general and then describe several approaches to white-box monitors.

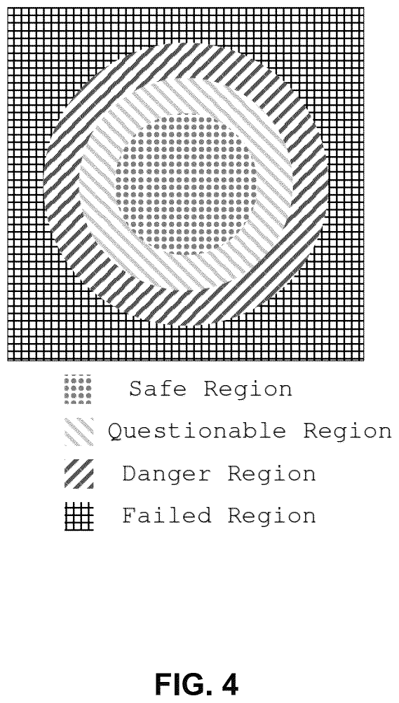

The main task of the white-box monitor is to determine how confident the AI controller is in its decision. If the white-box monitor can determine that the AI controller is not very confident in its actions, we can switch to the safe controller before a large drop in performance happens. We can think of this in the same fashion as the black-box monitor with the addition of a Questionable Region (FIG. 4) to the existing Safe Region, Danger Region, and Failed Region. This works as follows: if we are getting close to the area that the black-box monitor would have to save us, we might want to switch away from the AI controller to avoid a drop in performance. However, if the white-box monitor determines the AI controller has high confidence in its action, we will allow it to go up to the Danger Region, while if it detects low confidence, we will switch sooner. The higher the confidence, the farther into the Questionable Region the decision module will allow the system to progress before switching to the safe controller. We note that the white-box monitors can only make the change to the safe controller sooner, when the black-box monitor says it is in the Danger Region, it always switches to the safe controller regardless of what the white-box monitors say.

The white-box monitor can also be used when switching back to the AI controller from the safe controller when the system has reached the Questionable Region. The white-box monitor determines how confident the AI controller is, and its actions are only taken if it is very confident. This can help eliminate the oscillation issue described above since the white-box monitor can determine if we are likely to perform poorly when we switch back, which can prevent unnecessary switches to and from the safe controller.

White-box monitoring alone is not sufficient to keep the system safe. The white-box monitor can only predict the AI controller's own expected performance, given the current situation. If the situation is rapidly changing, or the white-box monitor does not assess the situation correctly, the black-box monitor is still necessary to ensure overall system correctness.

Types of White-Box Monitors: There are many possible white-box monitors with varying costs for different situations. Here we describe three general forms. The first and cheapest monitor uses information that the AI system already calculates in its prediction, for example, in Proximal Policy Optimization (PPO) models one of the final steps is a score for each possible decision with its likelihood of being chosen, one can look at the magnitude of the score of the chosen decision to determine its confidence, or how likely it was to choose its selected option compared to any other option. If many possible options have similar scores, or the selected option has a low score, it indicates that the AI controller may have low confidence in its decision. This monitoring technique is very cheap since it uses calculations that the standard model is performing regardless. While this monitoring technique is cheap, it relies on the specifics of the AI model.

A second possible monitor is to train multiple different models to solve the problem and compare the results from all the models. If the models all agree then it indicates that the state space in question was trained for, and thus we are likely to perform well, but if the models disagree then we are likely in a region of the state space that was not very well-trained and thus left more up to randomness and as such we are less confident in the decision. This monitor is relatively cheap at inference time since inference for most models is quite cheap but can have a high start-up cost since multiple models must be trained. Training can often take considerable time and computing resources.

Another type of white-box monitor is simulation based. If the AI controller performs poorly in a simulation of the future, you assume it would also perform poorly in the true situation. This makes the assumption that the near future is similar to the near past, which allows us to simulate the future with a high degree of confidence. It also assumes that it is computationally feasible to simulate the controller's environment in real time. This is the most expensive approach, and most importantly, the cost of this approach must be paid at runtime, rather than paid in advanced, like the multiple models approach.

This simulation based monitor is fundamentally different from other kinds of white-box monitors since it requires no information about how the AI controller works, only the ability to use it. It is able to use the AI controller like a black-box and determine a confidence score. We still consider it a white-box monitor since it requires information about the AI controller in general, as opposed to the black-box monitor which only needs state information about the environment. One benefit of the simulation based white-box monitor is its generality in that no other information about the controller needs to be known, and thus it could be used in situations where training other models or looking into the state of the AI controller was impractical or impossible, such as with proprietary systems.

### C. Exemplary RADICS Architecture

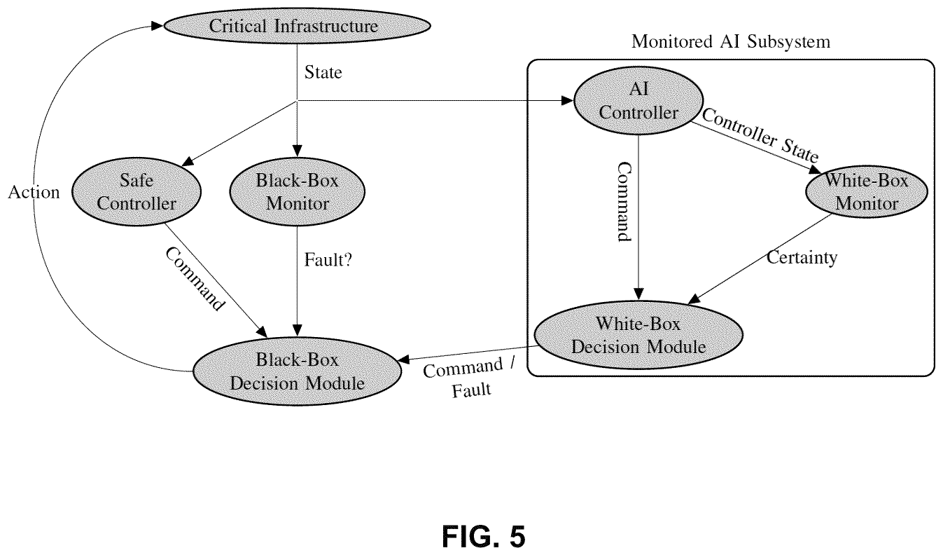

Exemplary RADICS architecture can be seen in FIG. 5. The simple AI controller from FIG. 3a has been expanded into an entire AI subsystem. The AI subsystem makes a decision based on the state, then uses the white-box monitor to check the controller confidence in that decision. Lastly, the white-box decision module determines the confidence from the output of the white-box monitor and decides how strongly it should suggest the command from the AI controller to the overall black-box decision module. For correctness, the black-box monitor still makes the final decision. However, the white-box monitor can help predict faults, limiting their impact and can also help alleviate the oscillation concerns.

Some further aspects are defined in the following clauses:

Clause 1: A system, comprising: an infrastructure component configured to produce at least one infrastructure output; a black-box monitoring subsystem configured to receive state information from the infrastructure component and to communicate with at least one decision module component; a white-box monitoring subsystem configured to receive the state information from the infrastructure component and to communicate with the at least one decision module component; and, a safe controller and an artificial intelligence (AI) controller configured to receive the state information from the infrastructure component, which safe and AI controllers comprise at least one processor and at least one memory communicatively coupled to the at least one processor, which at least one memory stores instructions which, when executed on the at least one processor, perform operations comprising: receiving the state information at least at the safe and AI controllers; using the AI controller to control the infrastructure output of the infrastructure component when the state information indicates that the system is in a safe region; using the safe controller to control the infrastructure output of the infrastructure component when the state information indicates that the system is in a danger region; and, using output produced by the white-box monitoring subsystem to select whether to use the AI controller or the safe controller to control the infrastructure output of the infrastructure component when the state information indicates that the system is in a questionable region.

Clause 2: The system of Clause 1, wherein the white-box monitoring subsystem comprises a plurality of white-box monitoring components.

Clause 3: The system of Clause 1 or Clause 2, wherein the at least one decision module component comprises a black-box decision module and a white-box decision module, which white-box decision module communicates with the black-box decision module.

Clause 4: The system of any of Clauses 1-3, wherein the infrastructure component comprises a power grid system.

Clause 5: The system of any of Clauses 1-4, wherein the infrastructure component comprises a traffic light system.

Clause 6: The system of any of Clauses 1-5, wherein the system comprises an electronic neural network.

Clause 7: A method of controlling the infrastructure output of the infrastructure component using the system of any of Clauses 1-6.

Clause 8: A computer readable media comprising non-transitory computer executable instruction which, when executed by at least one electronic processor of a system, perform at least: receiving state information at least at safe and artificial intelligence (AI) controllers configured to receive the state information from an infrastructure component; using the AI controller to control infrastructure output of the infrastructure component when the state information indicates that the system is in a safe region; using the safe controller to control the infrastructure output of the infrastructure component when the state information indicates that the system is in a danger region; and, using output produced by a white-box monitoring subsystem to select whether to use the AI controller or the safe controller to control the infrastructure output of the infrastructure component when the state information indicates that the system is in a questionable region.

Clause 9: The computer readable media of Clause 8, wherein the white-box monitoring subsystem comprises a plurality of white-box monitoring components.

Clause 10: The computer readable media of Clause 8 or Clause 9, wherein at least one decision module component of the system comprises a black-box decision module and the white-box decision module, which white-box decision module communicates with the black-box decision module.

Clause 11: The computer readable media of any of Clauses 8-10, wherein the infrastructure component comprises a power grid system.

Clause 12: The computer readable media of any of Clauses 8-11, wherein the infrastructure component comprises a traffic light system.

Clause 13: The computer readable media of any of Clauses 8-12, wherein the system comprises an electronic neural network.

Clause 14: A method of controlling an infrastructure output of an infrastructure component using a system comprising a computer, the method comprising: receiving, by the computer, state information at least at safe and artificial intelligence (AI) controllers of the system, which safe and AI controllers are configured to receive the state information from the infrastructure component; using the AI controller to control infrastructure output of the infrastructure component when the state information indicates that the system is in a safe region; using the safe controller to control the infrastructure output of the infrastructure component when the state information indicates that the system is in a danger region; and, using output produced by a white-box monitoring subsystem to select whether to use the AI controller or the safe controller to control the infrastructure output of the infrastructure component when the state information indicates that the system is in a questionable region.

Clause 15: The method of Clause 14, wherein the white-box monitoring subsystem comprises a plurality of white-box monitoring components.

Clause 16: The method of Clause 14 or Clause 15, wherein at least one decision module component of the system comprises a black-box decision module and the white-box decision module, which white-box decision module communicates with the black-box decision module.

Clause 17: The method of any of Clauses 8-16, wherein the infrastructure component comprises a power grid system.

Clause 18: The method of any of Clauses 8-17, wherein the infrastructure component comprises a traffic light system.

Clause 19: The method of any of Clauses 8-18, wherein the system comprises an electronic neural network.

Clause 20: The method of any of Clauses 8-19, comprising adjusting the infrastructure output of the infrastructure component when the state information indicates that the system is in the questionable region.

While the foregoing disclosure has been described in some detail by way of illustration and example for purposes of clarity and understanding, it will be clear to one of ordinary skill in the art from a reading of this disclosure that various changes in form and detail can be made without departing from the true scope of the disclosure and may be practiced within the scope of the appended claims. For example, all the methods, systems, and/or computer readable media or other aspects thereof can be used in various combinations. All patents, patent applications, websites, other publications or documents, and the like cited herein are incorporated by reference in their entirety for all purposes to the same extent as if each individual item were specifically and individually indicated to be so incorporated by reference.

What is claimed is:

1. A system, comprising:
an infrastructure component configured to produce at least one infrastructure output;
a black-box monitoring subsystem configured to receive state information from the infrastructure component and to communicate with at least one decision module component;
a white-box monitoring subsystem configured to receive the state information from the infrastructure component and to communicate with the at least one decision module component; and,
a safe controller and an artificial intelligence (AI) controller configured to receive the state information from the infrastructure component, which safe and AI controllers comprise at least one processor and at least one memory communicatively coupled to the at least one processor, which at least one memory stores instructions which, when executed on the at least one processor, perform operations comprising:
receiving the state information at least at the safe and AI controllers;
using the AI controller to control the infrastructure output of the infrastructure component when the state information indicates that the system is in a safe region;
using the safe controller to control the infrastructure output of the infrastructure component when the state information indicates that the system is in a danger region; and,
using output produced by the white-box monitoring subsystem to select whether to use the AI controller or the safe controller to control the infrastructure output of the infrastructure component when the state information indicates that the system is in a questionable region.

2. The system of claim 1, wherein the white-box monitoring subsystem comprises a plurality of white-box monitoring components.

3. The system of claim 1, wherein the at least one decision module component comprises a black-box decision module and a white-box decision module, which white-box decision module communicates with the black-box decision module.

4. The system of claim 1, wherein the infrastructure component comprises a power grid system.

5. The system of claim 1, wherein the infrastructure component comprises a traffic light system.

6. The system of claim 1, wherein the system comprises an electronic neural network.

7. A method of controlling the infrastructure output of the infrastructure component using the system of claim 1.

8. A computer readable media comprising non-transitory computer executable instruction which, when executed by at least one electronic processor of a system, perform at least:
receiving state information at least at safe and artificial intelligence (AI) controllers configured to receive the state information from an infrastructure component;
using the AI controller to control infrastructure output of the infrastructure component when the state information indicates that the system is in a safe region;
using the safe controller to control the infrastructure output of the infrastructure component when the state information indicates that the system is in a danger region; and,
using output produced by a white-box monitoring subsystem to select whether to use the AI controller or the safe controller to control the infrastructure output of the infrastructure component when the state information indicates that the system is in a questionable region.

9. The computer readable media of claim 8, wherein the white-box monitoring subsystem comprises a plurality of white-box monitoring components.

10. The computer readable media of claim 8, wherein at least one decision module component of the system comprises a black-box decision module and the white-box decision module, which white-box decision module communicates with the black-box decision module.

11. The computer readable media of claim 8, wherein the infrastructure component comprises a power grid system.

12. The computer readable media of claim 8, wherein the infrastructure component comprises a traffic light system.

13. The computer readable media of claim 8, wherein the system comprises an electronic neural network.

14. A method of controlling an infrastructure output of an infrastructure component using a system comprising a computer, the method comprising:
receiving, by the computer, state information at least at safe and artificial intelligence (AI) controllers of the system, which safe and AI controllers are configured to receive the state information from the infrastructure component;
using the AI controller to control infrastructure output of the infrastructure component when the state information indicates that the system is in a safe region;
using the safe controller to control the infrastructure output of the infrastructure component when the state information indicates that the system is in a danger region; and,
using output produced by a white-box monitoring subsystem to select whether to use the AI controller or the safe controller to control the infrastructure output of the infrastructure component when the state information indicates that the system is in a questionable region.

15. The method of claim 14, wherein the white-box monitoring subsystem comprises a plurality of white-box monitoring components.

16. The method of claim 14, wherein at least one decision module component of the system comprises a black-box decision module and the white-box decision module, which white-box decision module communicates with the black-box decision module.

17. The method of claim 14, wherein the infrastructure component comprises a power grid system.

18. The method of claim 14, wherein the infrastructure component comprises a traffic light system.

19. The method of claim 14, wherein the system comprises an electronic neural network.

20. The method of claim 14, comprising adjusting the infrastructure output of the infrastructure component when the state information indicates that the system is in the questionable region.
